(19) United States
(12) Patent Application Publication
(10) Pub. No.: US 2012/0007872 A1
(43) Pub. Date: Jan. 12, 2012

(54) Method And Computer Program For Operation Of A Multi-Buffer Graphics Memory Refresh, Multi-Buffer Graphics Memory Arrangement And Communication Apparatus

(76) Inventor: Aleksandar Filipov, Limhamn (SE)

(21) Appl. No.: 13/122,492

(22) PCT Filed: Sep. 24, 2009
(86) PCT No.: PCT/EP2009/062377

§ 371 Date: Sep. 26, 2011

Related U.S. Application Data
(60) Provisional application No. 61/104,375, filed on Oct. 10, 2008.

(30) Foreign Application Priority Data
Oct. 2, 2008 (EP) 08165770.2

(51) Int. Cl. G09G 5/393

(52) U.S. Cl. 345/531

(57) ABSTRACT

A method for refresh operation of a multi-buffer arrangement for a graphics memory having a first and a second operation mode is disclosed. The method comprises writing information to one of a first and second buffers of the multi-buffer arrangement; presetting the one of the buffers, when previous refresh operation was in the second operation mode, before the writing of information to the one of the buffers; dynamically selecting one of the first and the second operation mode; copying information, when in the first operation mode, between a first and a second buffer of the multi-buffer arrangement, before the writing of information to the one of the buffers; and providing information from the buffer arrangement to a display. Computer programs, multi-buffer arrangements and communication apparatuses comprising such multi-buffer arrangements are also disclosed.

### TECHNICAL FIELD

The present invention relates to a method for refresh operation of a multi-buffer graphics memory, a computer program for implementing the method, a multi-buffer graphics memory arrangement for providing image data to a display, and a communication apparatus comprising such an arrangement.

### BACKGROUND

In computer graphics, double-buffering, sometimes called ping-pong buffering, is a technique used to reduce or remove visible artifacts from the drawing process of a display. It may be implemented in either software or hardware.

Computer monitors, and also displays of for example mobile telephones constantly redraw the visible video page, say at around 60 times a second, implying difficulties in making changes to the video page, such as creation or movement of complex objects on the display, without the monitor showing the results before the graphics operation is complete, i.e. the application writing the content to be viewed. This may result in ugly artifacts such as flickering, tearing and shearing.

A software implementation of double-buffering uses a video page stored in a system memory that all drawing operations are written to. When a drawing operation is considered complete, the whole page, or a portion of it, is copied into a display memory in one operation. This is generally synchronized so that copy operation is ahead of the display's raster beam so that ideally, if the copy is faster than the video beam, artifacts are avoided. This software method is not always flawless. Most notably, double-buffering necessarily requires more graphics memory and processing time than single buffering because of the graphics memory allocated for the buffer itself and the synchronization copy, respectively.

The hardware method is also known as page flipping. In this approach, two graphics pages in the graphics memory are used. At any one time, one page is actively being displayed by the display, while the other, background page is being drawn. When drawing is complete, the roles of the two pages are switched, so that the previously shown page is now being modified, and the previously drawn page is now being shown. The page-flip is typically accomplished by modifying the value of a pointer to the beginning of the display data in the graphics memory.

The hardware method guarantees artifacts will not be seen as long as the pages are switched over during the display's vertical blank period when no video data is being drawn. This method requires twice the amount of graphics memory that is required for a single video page. The currently active and visible buffer may be considered as a front buffer, while the background page may be considered as a back buffer.

Screen rendering technologies often benefit from that the previous data shown on the display is maintained in the graphics memory. This gives an application possibility to draw layers. This is particularly beneficial for some applications, while others do not benefit from it since they redraw the full screen at every refresh. The latter ones thus only suffer from the loss of system performance due to the operations of flipping the buffers.

U.S. Pat. No. 6,900,813 B1 discloses a method and apparatus with adaptable double-buffering capabilities, where a graphics driver checks specific data in a status register to determine the number of buffers that the application is using. A problem with this approach is that a particular structure and signaling scheme need to be formed, which all applications to be executed have to be adapted for. In practice, this may lead to a non-negligible number of applications, that are not adapted to this, which is executed will degrade performance of display control.

Therefore, there is need for an approach which more flexibly adapts to the demands of the application.

### SUMMARY

The present invention aims to at least alleviate the above stated problem. The present invention is based on the understanding that a display controller can be able to distinguish between the two types of applications based on their refresh operation instructions provided to the display controller, and also make a prediction of probable operation based on previous operation, from which the display controller then is able to adapt its operation of the display buffers to streamline operation.

According to a first aspect, there is provided a method for refresh operation of a multi-buffer arrangement for a graphics memory having a first and a second operation modes. The method comprises writing information to one of a first and second buffers of the multi-buffer arrangement; presetting the one of the buffers, when previous refresh operation was in the second operation mode, before the writing of information to the one of the buffers; dynamically selecting one of the first and the second operation mode; copying information, when in the first operation mode, between a first and a second buffer of the multi-buffer arrangement, before the writing of information to the one of the buffers; and providing information from the buffer arrangement to a display.

The selecting of operation mode may comprise, when operation mode of previous refresh operation was the first operation mode and instructions of present refresh operation comprises a preset instruction prior a writing instruction, selecting the second operation mode; when operation mode of previous refresh operation was the second operation mode and instructions of present refresh operation lack a preset instruction prior a writing instruction, selecting the first operation mode; and otherwise, selecting the operation mode to be the same as the previous operation mode.

The method may further comprise, when previous refresh operation was in the second operation mode and the first operation mode was selected, halting the writing of information to the one of the buffers and the providing of information from the buffer arrangement to the display; performing the copying of data from the first buffer to the second buffer; and then resuming the writing of information to the one of the buffers and the providing of information from the buffer arrangement to the display.

The method may further comprise reading the operation mode of the previous refresh operation from a register; and storing the selected operation mode in the register.

The providing of information from the buffer arrangement to the display may comprise providing the information from the other of the first and second buffers of the multi-buffer arrangement. The providing of information from the other of the first and second buffers may be, when the operation mode is selected to be the first operation mode, performed after the copying of information between the first and the second buffer. The providing of information from the other of the first and second buffers may be, when the operation mode is selected to be the second operation mode, performed after the selecting of operation mode.

The method may be performed for each refresh cycle of the refresh operation.

According to a second aspect, there is provided a computer program comprising computer program code comprising instructions to cause a processor on which the computer program code is executed to perform the method according to the first aspect.

According to a third aspect, there is provided a multi-buffer graphics memory arrangement for providing image data to a display, having a first and a second operation mode. The arrangement comprises a first buffer; a second buffer; and a controller. The controller is arranged to enable writing of information to one of a first and second buffers of the multi-buffer arrangement; preset the one of the buffers, when previous refresh operation was in the second operation mode, before enabling writing information to the one of the buffers; dynamically select one of the first and the second operation mode; copy information, when in the first operation mode, between a first and a second buffer of the multi-buffer arrangement, before enabling the writing of information to the one of the buffers; and provide information from the buffer arrangement to a display.

The controller may, upon the selection of operation mode, be arranged to, when operation mode of previous refresh operation was the first operation mode and instructions of present refresh operation comprises a preset instruction prior a writing instruction, select the second operation mode; when operation mode of previous refresh operation was the second operation mode and instructions of present refresh operation lack a preset instruction prior a writing instruction, select the first operation mode; and otherwise, select the operation mode to be the same as the operation mode of the previous refresh operation.

The controller may further be arranged to, when previous refresh operation was in the second operation mode and the first operation mode was selected, halt the writing of information to the one of the buffers and the providing of information from the buffer arrangement to the display; perform the copying of data from the first buffer to the second buffer; and then resume the writing of information to the one of the buffers and the providing of information from the buffer arrangement to the display.

The arrangement may further comprise a register, wherein the controller is arranged to read the operation mode of the previous refresh operation from the register; and store the selected operation mode in the register.

The arrangement may further comprise an output, such that the controller provides the information from the other of the first and second buffers of the multi-buffer arrangement to the output. The controller may be arranged to enable the provision of information from the other of the first and second buffers, when the operation mode is selected to be the first operation mode, after the copy operation of information between the first and the second buffer is finished.

The controller may be arranged to enable the provision of information from the other of the first and second buffers, when the operation mode is selected to be the second operation mode, after the selection of operation mode is finished.

The arrangement may further comprise an input arranged to receive instructions and image information, such that the received instructions are processed by the controller and the received image information are provided for temporary storage in any of the buffers.

According to a fourth aspect, there is provided a communication apparatus comprising a display; and an arrangement according to the third aspect.

In this context, the term ‘refresh operation’ means the operation of providing content information to the buffer arrangement, and possibly between the buffers of the buffer arrangement (i.e. ‘copying’ where this is performed), as well as providing information from the buffer arrangement to the display. Thus, one refresh operation is performed for one screen update. The term ‘buffer writing’ means the provision of content information to one of the buffers of the buffer arrangement.

An advantage of embodiments of the invention is that operation of the multi-buffer arrangement is predicted in a simple way which saves time at most instants, which improves performance of refresh operation.

In particular, an advantage of embodiments of the invention is that copying between buffers can be avoided when not necessary, based on the dynamic selection of operation mode made from instructions and from operation mode of previous refresh operation.

### BRIEF DESCRIPTION OF DRAWINGS

FIG. 1 illustrates an exemplary operation of two buffers over time when operating according to a first operation mode.

FIG. 2 illustrates another exemplary operation of two buffers over time when operating according to a first operation mode.

FIG. 3 illustrates an exemplary operation of three buffers over time when operating according to a first operation mode.

FIG. 4 illustrates an exemplary operation of two buffers over time when operating according to a second operation mode.

FIG. 5 is a state diagram that schematically illustrates dynamic selection of operation mode.

FIG. 6 illustrates an exemplary operation of two buffers over time when initially operating according to a first operation mode, and then making a transition to a second operation mode.

FIG. 7 illustrates an exemplary operation of two buffers over time when initially operating according to the second operation mode, and then making a transition to a first operation mode.

FIG. 8 is a flow chart illustrating method according to an embodiment of the invention for a refresh cycle of a refresh operation of a multi-buffer arrangement.

FIG. 9 is a flow chart illustrating method according to an embodiment of the invention for a refresh cycle of a refresh operation of a multi-buffer arrangement.

FIG. 10 is a flow chart schematically illustrating an embodiment of the invention.

FIG. 11 schematically illustrates a computer readable medium which can be loaded and executed by a processing means, processor, or computer.

FIG. 12 is a block diagram schematically illustrating an arrangement for multi-buffer graphics memory control according to an embodiment.

FIG. 13 is a block diagram schematically illustrating a communication apparatus.

### DETAILED DESCRIPTION

A display controller can be able to distinguish between types of applications based on their refresh operation instructions provided to the display controller, e.g. from a processor executing one or more applications, from which the display controller then is able to adapt its operation of display buffers for making refresh operations more efficient. In the following, embodiments of methods for controlling display refresh, and devices for implementation will be described. It is to be noted that the ‘first’ and ‘second’ buffers mentioned in the description of the methods below are not to be physically construed, since the ping-pong buffering relies on the two functional elements, i.e. the first and second buffers, can be flipped, i.e. the physical buffers can be functionally interchanged. Solutions with further buffers are also possible, e.g. 3 buffers, with the below presented embodiments although the given examples are elucidated for the case with 2 buffers for the sake of easier understanding and conciseness. The use of more than 2 buffers may be beneficial when provision of information from a buffer to the display can take long time in relation to writing of the buffers and the rate at which new information arrives to be written to the buffers, wherein the buffers are written in turn while one buffer is accessed for provision of information to the display. A feasible approach is to provide the latest updated buffer when a display refresh operation is about to start if there are several written buffers available.

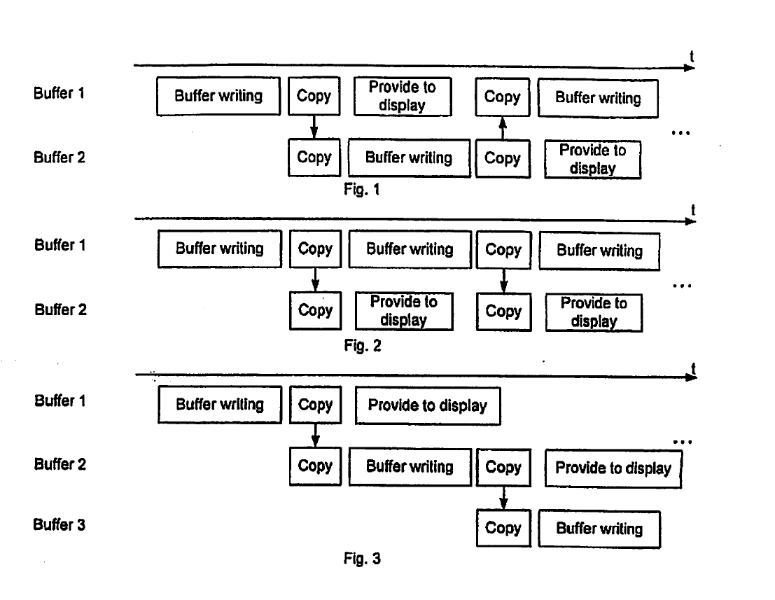

FIG. 1 illustrates an exemplary operation of two buffers over time when operating according to a first operation mode, i.e. an operation mode suitable for layered graphics. When a first buffer has been written, the information stored in the first buffer is copied to a second buffer. Thereafter, the second buffer is written, i.e. information of the buffer is updated such that a layered content is present in the buffer, and the first buffer provides its information to the display. The procedure then repeats, but with the buffers flipped, i.e. the information stored in the second buffer is copied to the first buffer, and then the first buffer is written, while the second buffer provides its information to the display.

FIG. 2 illustrates another exemplary operation of two buffers over time when operating according to a first operation mode, i.e. an operation mode suitable for layered graphics. When a first buffer has been written, the information stored in the first buffer is copied to a second buffer. Thereafter, the first buffer is written again, i.e. information of the buffer is updated such that a layered content is present in the buffer, and the second buffer provides its information to the display. The procedure then repeats and the information stored in the first buffer is copied to the second buffer, then the first buffer is written, and the second buffer provides its information to the display.

FIG. 3 illustrates an exemplary operation of three buffers over time when operating according to a first operation mode, i.e. an operation mode suitable for layered graphics. When a first buffer has been written, the information stored in the first buffer is copied to a second buffer. Thereafter, the second buffer is written, and the first buffer provides its information to the display. The provision of information to the display may take longer time than the writing of the second buffer, so the first buffer is not available for copying or writing. Thus, the information stored in the second buffer is copied to a third buffer. Thereafter, the third buffer is written, and the second buffer provides its information to the display. Then information stored in the third buffer is copied to the first buffer, and then the first buffer is written, and the third buffer provides its information to the display. The procedure then repeats and the information stored in the first buffer is copied to the second buffer, then the second buffer is written, and the first buffer provides its information to the display.

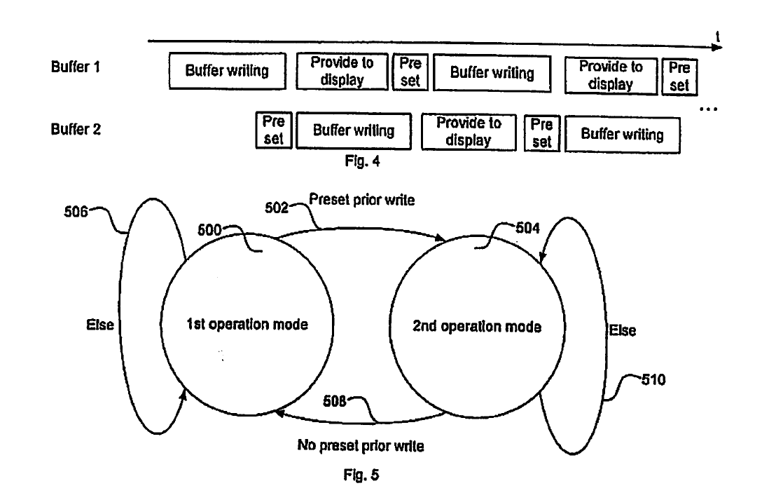

FIG. 4 illustrates an exemplary operation of two buffers over time when operating according to a second operation mode, i.e. an operation mode which is optimized for operation when no layered graphics are present. A first buffer is written. The information stored in the first buffer need not be preserved. The second buffer is preset, e.g. cleared or provided with a predetermined background information, and then written. The first buffer provides its information to the display. The procedure then repeats, but with the buffers flipped, i.e. the first buffer is preset and written, and the second buffer provides its information to the display.

FIG. 5 is a state diagram that schematically illustrates dynamic selection of operation mode. When in a first operation mode state 500, i.e. an operation mode suitable for layered graphics as elucidated above with reference to FIGS. 1 to 3, and a screen preset instruction is provided before buffer writing from an application providing image information to the buffer arrangement, a state transition 502 is made to a second operation mode state 504, i.e. an operation mode which is optimized for operation when no layered graphics are present as elucidated above with reference to FIG. 4. Otherwise, the operation mode is preserved 506 from one refresh operation to the next. When in the second operation mode state 504 and no preset instruction is provided, a state transition 508 to the first operation mode state 500 is made. Otherwise the operation mode is preserved 510 from one refresh operation to the next. Upon transition 508 to the first mode, a copy operation is performed to preserve information of the latest written buffer. This operation can be considered as a part of the first operation mode refresh operation, or as an intermediate state of the transition (not illustrated).

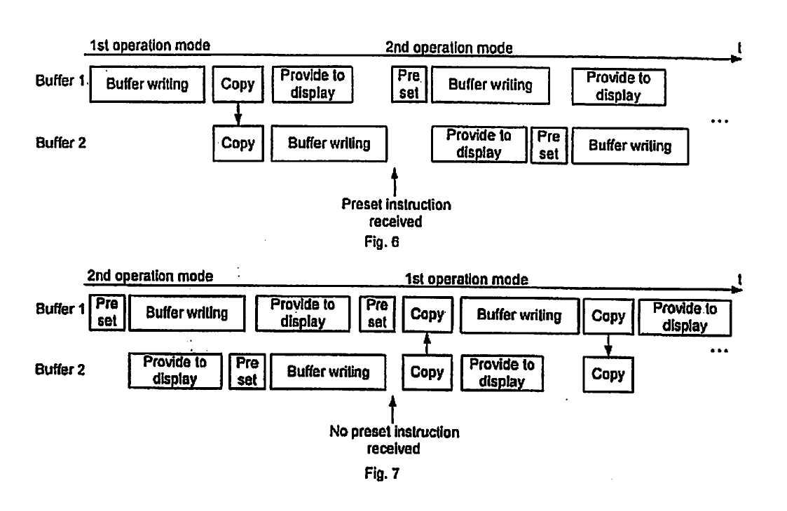

FIG. 6 illustrates an exemplary operation of two buffers over time when initially operating according to a first operation mode, i.e. an operation mode suitable for layered graphics, and then making a transition to a second operation mode, i.e. an operation mode which is optimized for operation when no layered graphics are present. When a first buffer has been written, the information stored in the first buffer is copied to a second buffer. Thereafter, the second buffer is written, i.e. information of the buffer is updated such that a layered content is present in the buffer, and the first buffer provides its information to the display. At the arrowed position in time, a preset instruction is received, as elucidated above, and the first buffer is preset and written, and the second buffer provides its information to the display, and the buffer arrangement now works in the second operation mode. For the next refresh operation cycle, the second buffer can be preset when the buffer has provided its content to the display, and buffer writing of the second buffer, as well as provision of content from the first buffer to the display can commence without performing any copying operation between the buffers. In the illustrated example, the preset instruction is received before any copying has been made. However, it is also possible that the preset instruction arrives during or after copying. In that case, the copying is disregarded, and the preset of the first buffer is performed, and the procedure goes on, as demonstrated above. Thus, at this occasion, for this single refresh cycle, a drawback of a prior art solution is experienced, i.e. effort is made for first copying buffers, and then the buffer to be written is preset anyway. For any other case, i.e. for most refresh cycles, this drawback is avoided by the approach of the invention.

FIG. 7 illustrates an exemplary operation of two buffers over time when initially operating according to the second operation mode, and then making a transition to a first operation mode. A first buffer is preset and then written, while content of a second buffer is provided to a display. Since operating in the second operation mode, the information stored in the first buffer is presumed not be preserved. Thus, the second buffer is preset, e.g. cleared or provided with a predetermined background information, and then written. The first buffer provides its information to the display. The procedure then repeats, but with the buffers flipped, i.e. the first buffer is preset, but at the arrowed position in time it is determined from instructions provided to the buffer arrangement that no preset instruction is received prior any buffer writing. Thus, a transition to the first operation mode is performed and the information stored in the second buffer, which is the last written buffer, is copied to the first buffer. Thereafter, the first buffer is written, i.e. information of the buffer is updated such that a layered content is present in the buffer, and the second buffer provides its information to the display. The procedure then repeats, but with the buffers flipped, i.e. the information stored in the first buffer is copied to the second buffer, and the second buffer is written, while the first buffer provides its information to the display.

In the examples of FIGS. 1 to 4, 6 and 7, timing and periodicity of the operations are chosen for illustrative purposes, and may vary according to preferences of the application providing instructions and image data, data bus capabilities of the buffer arrangement, and display properties. A controller handling operations of the buffer arrangement may work in different ways, but it is preferred that the controller works according to a suitable real-time scheme to provide proper arbiting between demands and properties of the application, data bus, and display.

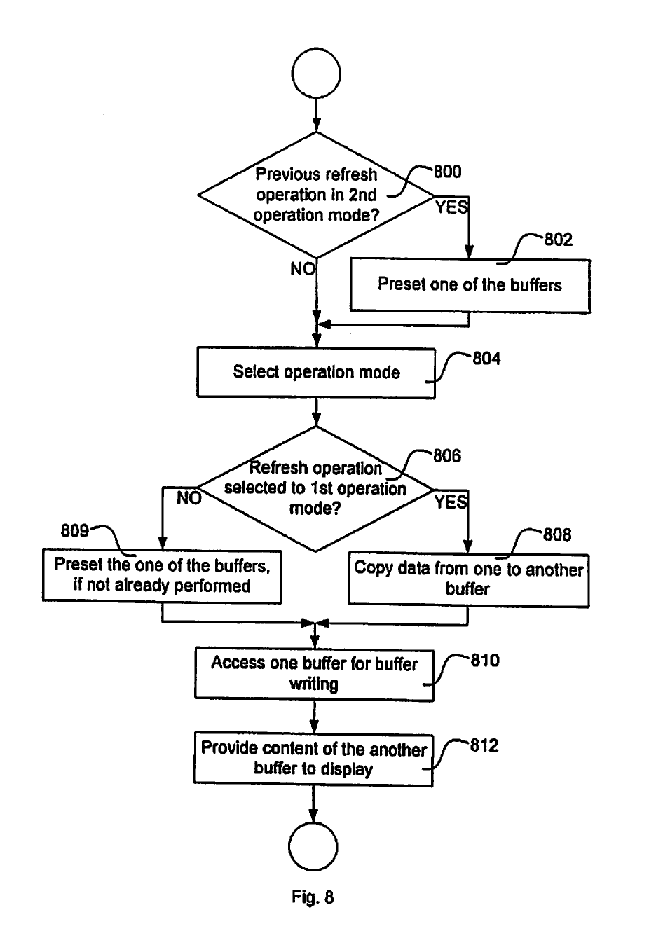

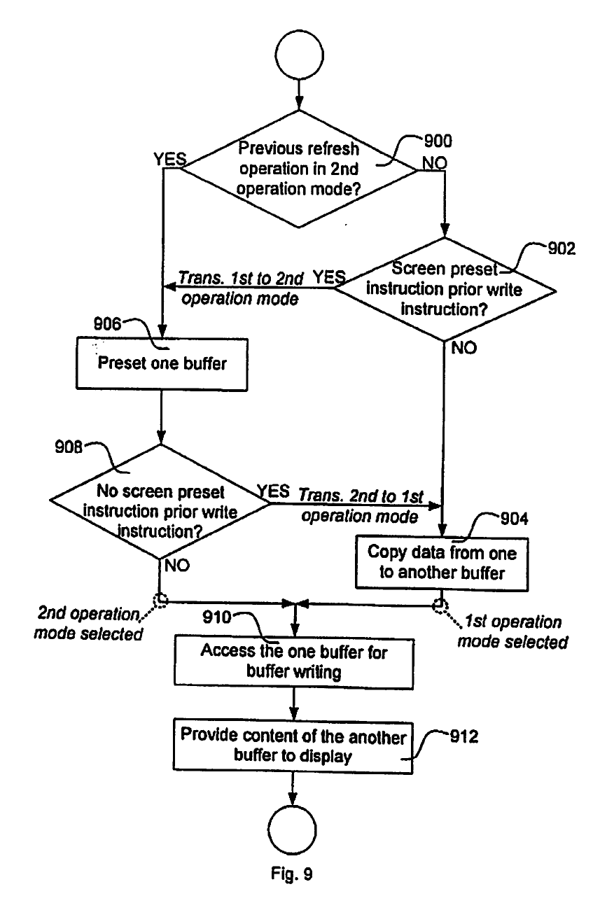

FIGS. 8 and 9 are flow charts schematically illustrating methods for refresh operation of a multi-buffer arrangement according to the principles demonstrated above. The flow charts are to be construed as schematical and exemplary, since the real-time nature of image provision and image buffering may change procedure at some time instances. However, for the understanding of the principles of the embodiments, the flow charts and the accompanying text will give suitable guidance for a person skilled in the art to perform the invention.

FIG. 8 is a flow chart illustrating method according to an embodiment of the invention for a refresh cycle of a refresh operation of a multi-buffer arrangement. In an operation mode history checking step 800, it is checked what operation mode previous refresh operation worked in. This can for example be done by checking a register holding information about the operation mode of the previous refresh operation. If the previous refresh operation was selected to the second operation mode, here using the same notation as with reference to FIGS. 1 to 7, the procedure proceeds with a preset step 802, where one of the buffers is preset, e.g. cleared or preset with predetermined background information. The “one” buffer is the buffer which is in turn for buffer writing, as has been demonstrated with reference to any of FIGS. 1 to 4, and due to flipping between physical buffers in some embodiments, the expressions “one” and “another” is used here for distinguishing between buffers during one refresh cycle, while the “one” and the “another” buffers may be different physical buffers during next refresh cycle. If the previous refresh operation was selected to be in the first operation mode, the preset step is not performed, and received instructions are consulted for selecting operation mode for present refresh operation in an operation mode selection step 804. The selection can be made such that, when the operation mode of the previous refresh operation was the first operation mode and instructions of present refresh operation comprises a preset instruction prior a writing instruction, the second operation mode is selected, when the operation mode of the previous refresh operation was the second operation mode and instructions of present refresh operation lack a preset instruction prior a writing instruction, the first operation mode is selected, and otherwise, the operation mode is selected to be the same as the previous operation mode. Then, in an operation mode checking step 806, the selected operation mode determines if the procedure should proceed to a buffer copying step 808, where data is copied from the one buffer to the another buffer, or to a possible presetting step 809, where the one buffer is preset if not already performed in step 802. Thus, the copying step 808 is performed if the first operation mode is selected, and the preset step 809 is performed if the second operation mode is selected and the step 802 has not been performed in the present refresh operation, i.e. upon transition from the first to the second operation mode. After any of steps 808 or 809, the procedure proceeds with a buffer writing step 810, where the one buffer is accessed for writing image information received from an application. The procedure also proceeds with a content providing step 812 where content, i.e. stored image data, of the another buffer is provided to the display for viewing. Here, it should be noted that timing between steps 810 and 812 can be different than what is indicated by the flow chart, and preferably these steps 810 and 812 are performed at least partly in parallel and their timings are most probably determined by the provision of image data from the application and the ability for the display to receive content, respectively.

FIG. 9 is a flow chart illustrating method according to an embodiment of the invention for a refresh cycle of a refresh operation of a multi-buffer arrangement. In an operation mode history checking step 900, it is checked what operation mode previous refresh operation worked in. This can for example be done by checking a register holding information about the operation mode of the previous refresh operation.

If the previous refresh operation was selected to be in the first operation mode, the procedure proceeds with an instruction checking step 902 where it is checked whether a screen preset instruction is received prior a buffer writing instruction. If no such instruction is received, the procedure proceeds with a data copying step 904 where data is copied from one buffer to another to preserve data for layered graphics, as elucidated above. Here, we can note that this mechanism inherently put the operation mode in the first operation mode, and the procedure continues with a buffer writing step 910 where the one buffer is accessed for writing image information received from an application. The procedure also proceeds with a content providing step 912 where content, i.e. stored image data, of the another buffer is provided to the display for viewing. Here, it should be noted that timing between steps 910 and 912 can be different than what is indicated by the flow chart, and preferably these steps 910 and 912 are performed at least partly in parallel and their timings are most probably determined by the provision of image data from the application and the ability for the display to receive content, respectively. On the other hand, if any such preset instruction is received, the procedure proceeds with a presetting step 906. In this case, we can note that a transition from the first to the second operation mode is performed by the mechanism.

If the previous refresh operation, determined in step 900, was selected to the second operation mode, here using the same notation as with reference to FIGS. 1 to 7, the procedure proceeds with a presetting step 906, where the one of the buffers is preset, e.g. cleared or preset with predetermined background information. The “one” buffer is the buffer which is in turn for buffer writing, as has been demonstrated with reference to any of FIGS. 1 to 4, and due to flipping between physical buffers in some embodiments, the expressions “one” and “another” is used here for distinguishing between buffers during one refresh cycle, while the “one” and the “another” buffers may be different physical buffers during next refresh cycle. The procedure then continues with an instruction checking step 908 where it is checked whether a screen preset instruction is received prior a buffer writing instruction. If no such instruction is received, the procedure proceeds with the data copying step 904 where data is copied from the one buffer to the another to preserve data for layered graphics, as elucidated above. Here, we can note that this mechanism inherently performs a transition from the second to the first operation mode. If a such instruction is received, we can note that this mechanism inherently put the operation mode in the second operation mode, and the procedure proceeds with the buffer writing step 910 where the one buffer is accessed for writing image information received from an application. The procedure also proceeds with the content providing step 912. The timing relation between the buffer writing step 910 and the content providing step 912 is as elucidated above.

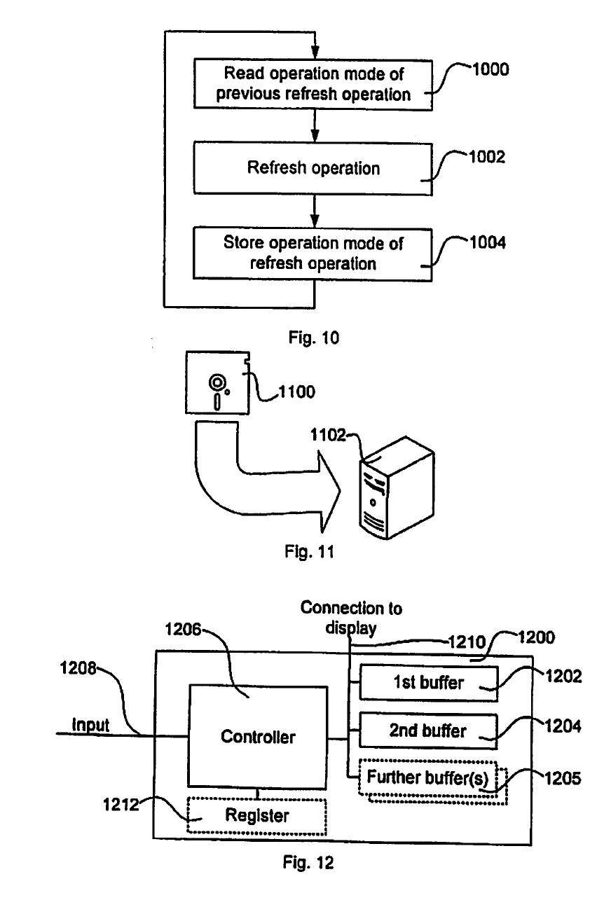

In the above description of the refresh operation with reference to FIGS. 8 and 9, the operation mode of the previous refresh operation is considered. FIG. 10 is a flow chart that schematically illustrates an embodiment for this consideration. In an operation mode reading step 1000, an indication on the operation mode of the previous refresh operation is read from a data storage, e.g. a register. The procedure proceeds with a refresh operation step 1002, which can be any of the refresh operation procedures presented with reference to FIG. 8 or 9. In an operation mode storing step 1004, the selected operation mode for the performed refresh operation is stored in the data storage. Here, it should be noted that the reading step 1000 and the operation mode storing step can be interleaved with sub-steps of the refresh operation step 1002 regarding timing.

The embodiments of the methods are suitable for implementation with aid of processing means, such as computers and/or processors, as the operation of modern displays highly rely on computerized signal processing. Therefore, there is provided computer programs, comprising instructions arranged to cause the processing means, processor, or computer to perform the steps of any of the methods according to any of the embodiments described with reference to any of FIGS. 1 to 10, in a display controller or display buffer arrangement. The computer programs preferably comprises program code which is stored on a computer readable medium 1100, as illustrated in FIG. 11, which can be loaded and executed by a processing means, processor, or computer 1102 to cause it to perform the methods, respectively, according to the embodiments, preferably as any of the embodiments described with reference to any of FIGS. 1 to 10. The computer 1102 and computer program product 1100 can be arranged to execute the program code sequentially where actions of the any of the methods are performed stepwise, but mostly be arranged to execute the program code on a real-time basis where actions of any of the methods are performed upon need and availability of data. The processing means, processor, or computer 1102 is preferably what normally is referred to as an embedded system. Thus, the depicted computer readable medium 1100 and computer 1102 in FIG. 11 should be construed to be for illustrative purposes only to provide understanding of the principle, and not to be construed as any direct illustration of the elements.

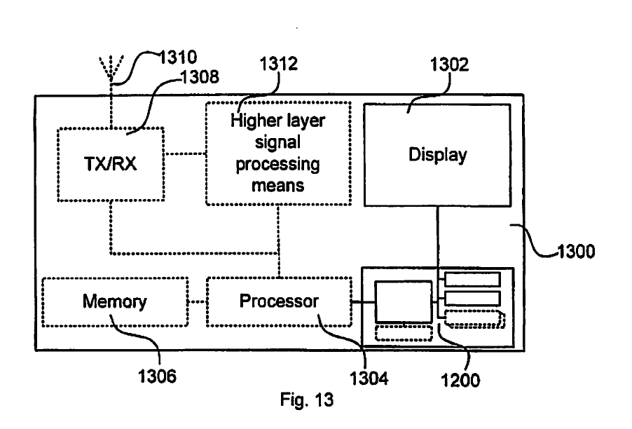

A multi-buffer graphics memory arrangement, or in everyday wording display controller, video controller or graphics controller arrangement, is here meant as an arrangement able to receive refresh instructions from one or more applications, and further able to render content without artifacts on a display to which the arrangement provides its output signals, by utilising multi-buffers when appropriate. FIG. 12 is a block diagram schematically illustrating such an arrangement 1200 according to an embodiment. The arrangement 1200 comprises a first buffer 1202 and a second buffer 1204 which each are able to hold content for a screen update of the display. Optionally, further buffers 1205 can be provided. The buffers 1202, 1204, 1205 are connected to a controller 1206, which also is connected to an instruction input of the arrangement 1200. On the instruction and data input 1208, the controller 1206 is provided with refresh operation instructions and image data from one or more applications that are arranged to provide content that is to be viewed on the display. The controller 1206 is arranged to determine if the refresh instructions include any indication on layered graphics, i.e. if multi-buffering is needed, as elucidated with reference to any of FIGS. 1 to 10 above. The determination can be performed by an instruction decoder, which can be included in the controller 1206 by means of software and/or hardware, or be a separate hardware entity being connected to and working together with the controller 1206. The controller 1206 is arranged to perform resetting, copying, buffer writing, and providing of content to an output 1210 connectable to a display according to what has been demonstrated with reference to any of FIGS. 1 to 10. Optionally, a register 1212 is provided in the arrangement 1200 to store the operation mode of a previous refresh operation cycle. The controller 1206 can then read the operation mode of the previous operation cycle from the register 1212, and store the selected operation mode for the present refresh operation cycle to be used in the next refresh operation cycle. The register 1212 can be a part of the controller 1206. The arrangement 1200 can be used in a communication apparatus 1300, as illustrated in the schematical block diagram of Fig. 13. The communication apparatus 1300 can be a mobile telephone, a computer, or any other apparatus arranged to perform applications that provides content to be viewed on a display. The communication apparatus 1300 comprises the arrangement 1200, which provides its output to a display 1302 of the communication apparatus 1300. The display 1302 in this context is an electronic visual display that generate visual information according to the signal provided by the arrangement 1200, either by generation of light and/or by modulation of available light during a process of reflection or transmission. The communication apparatus 1300 preferably further comprises a processor 1304 arranged to control operations of the communication apparatus 1300, which can include executing the applications, wherein the processor 1304 preferably is connected to the input of the arrangement 1300. The controller 1306 of the arrangement 1300 can be integrated with the processor 1304, which then performs the actions elucidated above. The processor 1304 preferably works with aid of a memory 1306, which is arranged to store and provide work and/or content information, and also instructions for the applications. Optionally, if the communication apparatus 1300 is an apparatus to be operated directly by a user, such as a mobile phone, the communication apparatus 1300 can comprise a user input interface, which can comprise input means such as microphone, keys, joystick, touchpad, touch sensitive screen, etc. The communication apparatus 1300 can further comprise a transceiver 1308, which via an antenna 1310 can perform wireless transmissions, which can be generated and/or processed in means 1312 for higher layer signal processing. The transceiver 1308 and the higher layer processing means 1312 are preferably operated under control of the processor 1304.

1. A method for refresh operation of a multi-buffer arrangement for a graphics memory having a first and a second operation modes, the method comprising:
writing information to one of a first and a second buffers of the multi-buffer arrangement;
presetting the one of the buffers, when previous refresh operation was in the second operation mode, before the writing of information to the one of the buffers;
dynamically selecting one of the first and the second operation mode;
copying information, when in the first operation mode, between a first and a second buffer of the multi-buffer arrangement, before the writing of information to the one of the buffers; and
providing information from the buffer arrangement to a display.

2. The method according to claim 1, wherein the selecting of operation mode comprises:
when operation mode of previous refresh operation was the first operation mode and instructions of present refresh operation comprises a preset instruction prior to a writing instruction, selecting the second operation mode;
when operation mode of previous refresh operation was the second operation mode and instructions of present refresh operation lack a preset instruction prior to a writing instruction, selecting the first operation mode; and
otherwise, selecting the operation mode to be the same as the previous operation mode.

3. The method according to claim 2, further comprising:
when previous refresh operation was in the second operation mode and the first operation mode was selected, halting the writing of information to the one of the buffers and the providing of information from the buffer arrangement to the display;
performing the copying of data from the first buffer to the second buffer; and
then resuming the writing of information to the one of the buffers and the providing of information from the buffer arrangement to the display.

4. The method according to claim 1, further comprising:
reading the operation mode of the previous refresh operation from a register; and
storing the selected operation mode in the register.

5. The method according to claim 1, wherein the providing of information from the buffer arrangement to the display comprises providing the information from the other of the first and second buffers of the multi-buffer arrangement.

6. The method according to claim 5, wherein the providing of information from the other of the first and second buffers, when the operation mode is selected to be the first operation mode, is performed after the copying of information between the first and the second buffer.

7. The method according to claim 5, wherein the providing of information from the other of the first and second buffers, when the operation mode is selected to be the second operation mode, is performed after the selecting of operation mode.

8. The method according to claim 1, wherein the method is performed for each refresh cycle of the refresh operation.

9. A non-transitory computer-readable medium comprising computer program code comprising instructions to cause a processor on which the computer program code is executed to perform the method according to claim 1.

10. A multi-buffer graphics memory arrangement for providing image data to a display, having a first and a second operation mode and comprising:
a first buffer and a second buffer; and
a controller being arranged to:
enable writing of information to one of the first and second buffers of the multi-buffer arrangement;
preset the one of the buffers, when previous refresh operation was in the second operation mode, before enabling writing information to the one of the buffers;
dynamically select one of the first and the second operation mode;
copy information, when in the first operation mode, between a first and a second buffer of the multi-buffer arrangement, before enabling the writing of information to the one of the buffers; and
provide information from the buffer arrangement to a display.

11. The arrangement according to claim 10, wherein the controller upon the selection of operation mode is arranged to:
when operation mode of previous refresh operation was the first operation mode and instructions of present refresh operation comprises a preset instruction prior to a writing instruction, select the second operation mode;
when operation mode of previous refresh operation was the second operation mode and instructions of present refresh operation lack a preset instruction prior to a writing instruction, select the first operation mode; and
otherwise, select the operation mode to be the same as the operation mode of the previous refresh operation.

12. The arrangement according to claim 11, wherein the controller is further arranged to:
when previous refresh operation was in the second operation mode and the first operation mode was selected, halt the writing of information to the one of the buffers and the providing of information from the buffer arrangement to the display;
perform the copying of data from the first buffer to the second buffer; and
then resume the writing of information to the one of the buffers and the providing of information from the buffer arrangement to the display.

13. The arrangement according to claim 10, further comprising a register, wherein the controller is arranged to:
read the operation mode of the previous refresh operation from the register; and
store the selected operation mode in the register.

14. The arrangement according to claim 10, further comprising an output, such that the controller provides the information from the other of the first and second buffers of the multi-buffer arrangement to the output.

15. The arrangement according to claim 14, wherein the controller is arranged to enable the provision of information from the other of the first and second buffers, when the operation mode is selected to be the first operation mode, after the copy operation of information between the first and the second buffers is finished.

16. The arrangement according to claim 13, wherein the controller is arranged to enable the provision of information from the other of the first and second buffers, when the operation mode is selected to be the second operation mode, after the selection of operation mode is finished.

17. The arrangement according to claim 10, further comprising an input arranged to receive instructions and image information, such that the received instructions are processed by the controller and the received image information is provided for temporary storage in any of the buffers.

18. A communication apparatus comprising:
a display; and
an arrangement according to claim 10.
